(19) United States
(12) Patent Application Publication
(10) Pub. No.: US 2005/0046064 A1
(43) Pub. Date: Mar. 3, 2005

(54) Foamed in-press sealer for consolidated cellulosic materials

(76) Inventors: Michael F. Halton, County Longford (IE); George A. Whelan, County Longford (IE); Catherine M. Joyce, County Longford (IE)

Correspondence Address: LINIAK, BERENATO & WHITE, LLC, 6550 ROCK SPRING DRIVE, SUITE 240, BETHESDA, MD, 20817, US

(21) Appl. No.: 10/869,026

(22) Filed: Jun. 17, 2004

Related U.S. Application Data
(60) Provisional application No. 60/479,917, filed on Jun. 20, 2003.

(51) Int. Cl. B29C 44/06; B29C 67/00

(52) U.S. Cl. 264/46.4

(57) ABSTRACT

The present invention relates to a method of making a consolidated cellulosic article. A cellulosic mat is provided. A latex-free, foamed sealer comprising a thermosetting resin is applied to the mat. The foam covered mat is then positioned between upper and lower platens of a press. The foam covered cellulosic mat is compressed between the upper and lower platens using heat and pressure. The foam sealer is de-foaming during compression, forming a consolidated article having a sealer coat. The present invention also relates to a door having at least one door facing with the sealer coat.

### CROSS-REFERENCE TO RELATED APPLICATION AND CLAIM TO PRIORITY:

This application is based on provisional application Ser. No. 60/479,917, filed Jun. 20, 2003, for Michael F. Halton et al., the disclosure of which is incorporated herein by reference and to which priority is claimed under 35 U.S.C. §120.

### FIELD OF THE INVENTION

The present invention relates to a method of making a consolidated cellulosic article having a sealer coat. A cellulosic mat is provided, and a latex-free, foamed sealer comprising a thermosetting resin is applied to the mat. The foam covered mat is positioned between upper and lower platens of a press. The foam covered cellulosic mat is then compressed between the upper and lower platens using heat and pressure. The foamed sealer is de-foamed, or collapsed, during compression in the press. The resulting consolidated article has a sealer coat. The present invention also provides for a door, having at least one door facing with the sealer coat thereon.

### BACKGROUND OF THE INVENTION

Man-made consolidated cellulosic articles, such as fiberboard, may be molded to have either planar or three-dimensional shapes and various design and structural features found in natural wood. Types of useful consolidated cellulosic articles include: (a) fiberboards such as hardboard, soft board, and medium-density fiberboard (MDF); and (b) chipboards such as particleboard, medium-density particleboard, and oriented strandboard (OSB). Composites of these boards are also useful.

Various processes can be used to produce consolidated cellulosic articles, such as those mentioned above. The principal processes for the manufacture of consolidated cellulosic articles include the following: (a) wet felted/wet pressed or “wet” processes, (b) dry felted/dry pressed or “dry” processes, and (c) wet felted/dry pressed or “wet-dry” processes.

Generally, in a wet process, cellulosic materials such as fibers (e.g., woody material that is subjected to fiberization to form wood fibers) are blended in a vessel with large amounts of water to form a slurry. The slurry preferably has sufficient water content to suspend a majority of the wood fibers and preferably has a water content of at least ninety percent by weight (“weight percent”) of the wood fibers. The slurry is deposited along with a synthetic resin binder, such as a phenol-formaldehyde resin, onto a water-pervious support member, such as a fine screen, where much of the water is removed to leave a wet mat of cellulosic material having, for example, a moisture content of about fifty weight percent, based on the dry weight of the fibers. The wet mat is transferred from the pervious support member to a press and consolidated under heat and pressure to form the molded wood composite article.

A wet-dry forming process typically includes blending cellulosic or wood fiber raw material in a vessel with large amounts of water having a pH of less than seven to form a slurry. This slurry is then blended with a resin binder. As in the wet process described above, the blend is then deposited onto a water-pervious support member, where a large percentage of the water is removed, thereby leaving a wet mat of cellulosic material having a water content of about fifty weight percent, for example. This wet mat is then transferred to an evaporation zone where much of the remaining water is removed by evaporation. The dried mat preferably has a moisture content of less than about thirty weight percent. The dried mat is then transferred to a press and consolidated under heat and pressure to form the wood composite article, such as a door facing or other desired shape.

In a dry process, the cellulosic material is generally conveyed in a gaseous stream or by mechanical means rather than a liquid stream. The cellulosic material may be first coated with a thermosetting resin binder, such as a phenol-formaldehyde resin. The cellulosic material is then randomly formed into a mat by air blowing one or more layers of the resin-coated cellulosic material onto a support member. The mat may optionally be subjected to pre-press drying. The mat, typically having a moisture content of less than about thirty weight percent and preferably less than about ten weight percent, is then pressed under heat and pressure to cure the thermosetting resin and to compress the mat into an integral consolidated article.

In the processes described above, the mat is typically consolidated in a press having upper and lower press platens. After compression, the resulting formed article may include a surface intended to be exteriorly disposed, such as a door facing. The quality and nature of this surface may therefore be an important aspect of the article. However, the compression process sometimes results in an article having a surface with undesirable qualities. For example, it may have cracks or voids caused when the consolidated material “sticks” to the platens as they release. This reduces surface hardness, and may also result in cracks, voids and porosity. Even if sufficient press release is achieved, the surface quality of the article may still be inadequate, given the fibrous characteristics of a consolidated cellulosic article.

In order to provide the desired surface characteristics, a sealer or finish coat may be applied to the molded article after removal from the press. Often, the surface color is also desirably altered by applying a primer to the surface of the molded article, thereby providing a ready-to-finish surface on the composite articles.

Attempts have been made to provide a primed and/or sealed composite article directly out of the press. In one such attempt, a pre-press polymer latex composition is applied to the surface of the mat as a foam. The polymer latex foam is dried into a hardened layer on the mat, and thereafter crushed and set during pressing of the mat into a coated, reconsolidated article. Although a primed composite article is produced, the method requires an extra latex foaming step, an extra heating step similar to other conventional manufacturing processes, and an additional crushing step. It has not proven to be time or cost efficient for some manufacturers.

In another attempt, a fast-setting, polymer latex primer coating that is formaldehyde-free is applied to the surface of the mat. The formaldehyde-free primer coating is formulated to form a chemically cross-linked polymer matrix as it is applied to the surface. The mat is then pressed under standard conditions. In another attempt, a polymer latex foam is applied to the mat. The foam must be collapsed on the mat between the time it is applied onto the surface of the mat and the time the mat contacts and is compressed by the press platens. Thus, time and cost are increased. To accelerate the foam collapse, air blowing, heating or applying a vacuum at the bottom of the mat immediately after the foam is applied may be used. However, time and cost are again increased with these additional requirements and equipment. In addition, latex-based compositions are relatively expensive. For example, a latex-based composition is more than three times as expensive as a formaldehyde-based resin used to form the slurry for cellulosic mats.

Therefore, there is a need for an in-press sealer composition and method for its application that is cost and time efficient.

### SUMMARY OF THE INVENTION

The present invention relates to a method of making a consolidated cellulosic article. A cellulosic mat is provided. A latex-free, foamed sealer comprising a thermosetting resin is applied to the cellulosic mat. The foam-covered mat is then positioned between upper and lower platens of a press. The foam-covered cellulosic mat is compressed between the upper and lower platens using heat and pressure. The foamed sealer is de-foamed, or collapsed, during the compressing step to form a consolidated article having a sealer coat.

The present invention also relates to a door comprising a peripheral frame having opposing sides, and first and second door facings. Each of the facings has an exterior surface and an interior surface secured to one of the sides of the frame. A sealer coat is provided on at least one of the exterior surfaces. The sealer has a substantially uniform thickness, and comprises a latex-free, thermosetting resin. The resin is preferably urea formaldehyde, phenol formaldehyde, melamine formaldehyde, melamine urea formaldehyde, or mixtures thereof.

The present invention also relates to a door facing which has an exterior surface and an interior surface for being secured to one of the sides of a doorframe. A sealer coat is provided on at least the exterior surface. The sealer has a substantially uniform thickness, and comprises a latex-free, thermosetting resin. The resin is preferably urea formaldehyde, phenol formaldehyde, melamine formaldehyde, melamine urea formaldehyde, or mixtures thereof.

A method of forming a sealed consolidated composite article is also disclosed. The method includes advancing an unconsolidated mat under a sealer foam dispensing head, and thereby applying a uniform layer of foamed sealer to the mat. The foam-covered mat is then positioned between the plates of a press. The press platens are closed and pressure and heat are applied, thereby collapsing and cross-linking the foam and consolidating the mat. The platens are thereafter opened, and the sealed, consolidated composite article removed.

### DESCRIPTION OF THE FIGURES

FIG. 1 is an elevational view of a press having upper and lower platens, with a cellullosic mat disposed between the platens and covered with a latex-free foamed sealer according to the present invention;

FIG. 2 is a sectional view of a cellulosic article with a sealer coat according to the present invention;

FIG. 3 is a side elevational schematic view of a system for dispensing foam onto the composite mat; and

FIG. 4 is a top plan schematic view of the system of FIG. 3.

### DETAILED DESCRIPTION OF THE INVENTION

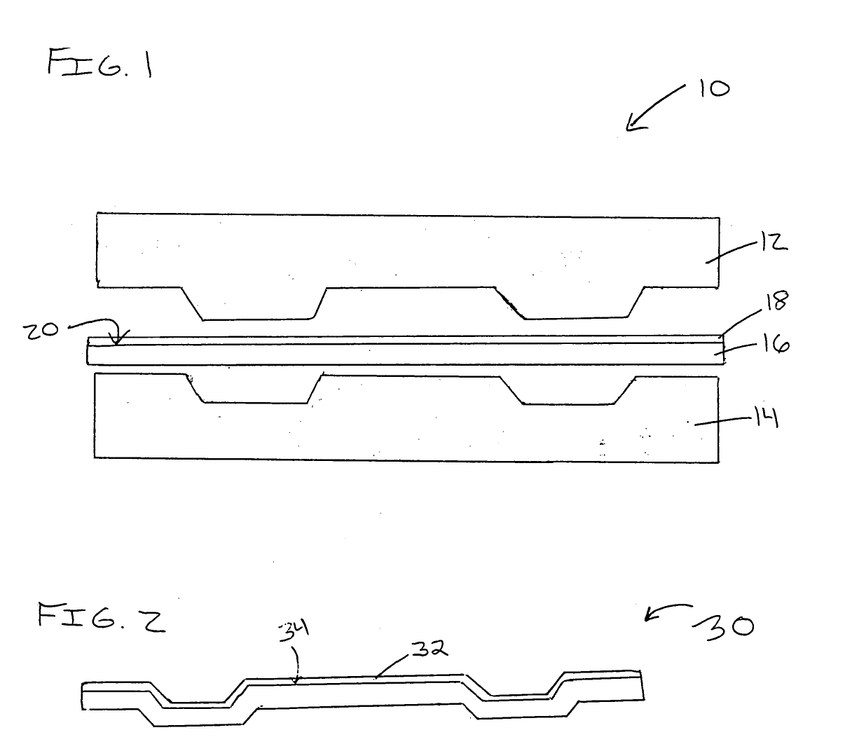

The present invention is directed to a method of making a consolidated cellulosic article having an out-of-press sealer coat. As best shown in FIG. 1, a press 10 is provided having an upper platen 12 and a lower platen 14, as well known in the art. A cellulosic mat 16 having a layer of latex-free, foamed sealer 18 on at least one major surface 20 is positioned between upper and lower platens 12, 14. Preferably, foamed sealer 18 is applied on surface 20, which may be an exteriorly disposed surface on an article such as an exterior surface of a door facing.

Prior to foaming foamed sealer 18, a non-foamed sealer composite is provided. The sealer composite is foamed to form foamed sealer 18. The sealer composite preferably comprises a thermosetting resin, preferably chosen from the group of urea formaldehyde, phenol formaldehyde, melamine formaldehyde, melamine urea phenol formaldehyde, melamine urea formaldehyde and mixtures thereof. It should be understood that other thermosetting resins having similar thermosetting properties may also be used. However, a formaldehyde-based resin is preferred given it is relatively inexpensive. For example, formaldehyde-based resins are less than one third the cost of a latex-based composition. Many conventional in-press or pre-press sealers are latex-based, and therefore are relatively expensive. A formaldehyde-based resin is often used in the slurry forming cellulosic mat 16. Therefore, use of the same resin for the sealer composite is cost efficient, convenient for manufacturers, and provides a good bond between the consolidated mat and the sealer coat.

Prior to forming foamed sealer 18, the resin in the sealer composite may be modified through the addition of plasticizers and/or rheology additives to impart the desired flexibility and viscosity to the resin. Suitable internal plasticizers include acetoguanamine, caprolactam, and para-toluene sulphonamide. Suitable external plasticizers include conventional phthalate plasticizers, such as DEHP (di-2-ethylhexyl phthalate), also known as DOP (di-octyl phthalate), DIDP (di-isodecyl phthalate), DMNP (di-isononyl phthalate), BBP (butyl benzyl phtalate), DIHP (di-isoheptyl phthalate), DPHP (di-propyl heptyl phthalate); aliphatic plasticisers, such as TXIB (Eastman Chemicals) 2,2,4-Trimethyl-1,3-Pentanediol, Diisobutrate; adipates, such as DEHA (diethylhexyl adipate); flame retardant plasticisers, such as phosphate ester plasticisers; and non-migratory polymeric plasticisers.

Alternatively, the non-foamed sealer composite may be plasticised through the addition of relatively small amounts of a soft low molecular weight thermoplastic acrylic resin. Carboxylated acrylic resins are first solublised in alcoholic alkaline water, and then added to the sealer composite. Examples of suitable acrylic resin types for this application include NeoCryl alkali soluble acrylic resins, such as NeoCryl Bt-20, NeoCryl BT-24 & NeoCryl BT-27, available from NeoResins Waalwijk of the Netherlands.

The sealer composite may also be modified through the addition of a thickening additive. Suitable thickening additives include methyl cellulose, methylhydroxyethyl cellulose, methylhydroxypropyl cellulose, hydroxyethyl cellulose, a polyurethane-based thickener, and an ammonium polyacrylate-based thickener. The non-foamed sealer composite has a preferred viscosity in the range of between about 200 centipoises (cps) to about 5000 cps, more preferably between about 500 cps to about 1500 cps.

The sealer composite may be pigmented so that the resulting consolidated article has a desired, out-of-press coloration. The pigment may include titanium dioxide and extender fillers. For example, the sealer composite may include a primary white pigment comprising rutile or anatase titanium dioxide with extender fillers. Suitable extender fillers include China clays, talc, calcium carbonate, and zinc oxide. The concentration of pigment in the sealer composite may vary depending on the desired coloration. Thus, pigmentation levels should be sufficient to provide the desired opacity in the collapsed (i.e. de-foamed), gelled and cured sealer coat.

Various pigment colorations are known in the art. The pigments preferably provide adequate chemical resistance, heat resistance and plasticiser bleed resistance. In addition, the pigments preferably have light fastness suitable for interior use. It is preferred that the pigments not be chemically constituted from heavy metals. Preferred pigments are set forth in Table I:

TABLE I

| | | |
|---|---|---|
| Name: | Chemical Class: | Generic Name: |

Black Pigments

| | | |
|---|---|---|
| Lamp Black | Carbon Black | CI Black 6 |
| Channel/Furnace | Carbon Black | CI Black 7 |
| Black Iron Oxide | Magnetite | CI Black 11 |

Blue Pigments

| | | |
|---|---|---|
| Phthalocyanine Blue Alpha | Phthalocyanine | CI Blue 15:1 |
| Phthalocyanine Blue Alpha | Phthalocyanine | CI Blue 15:2 |
| Phthalocyanine Blue Beta | Phthalocyanine | CI Blue 15:3 |
| Phthalocyanine Blue Beta | Phthalocyanine | CI Blue 15:4 |
| Phthalocyanine Blue Beta | Phthalocyanine | CI Blue 15:6 |
| Phthalocyanine Blue | Phthalocyanine | CI Blue 16 |
| (copper free) | | |
| Ultramarine Blue | Ultramarine | CI Blue 29 |
| Indanthrone Blue | Indanthrone Blue | CI Blue 60 |

Yellow Pigments

| | | |
|---|---|---|
| Iron Yellow Oxide | Synthetic Iron Oxide | CI Yellow 42 |
| Raw Sienna | Mineral Iron Oxide | CI Yellow 43 |
| | Limonite | |
| Diarylide Yellows | Dichloro-benzidine | CI Yellow 12 |
| | | CI Yellow 13 |
| | | CI Yellow 14 |
| | | CI Yellow 17 |
| | | CI Yellow 55 |
| | | CI Yellow 83 |
| Benzimidazolone Yellows | Mono Azo | CI Yellow 120 |
| | | CI Yellow 151 |
| | | CI Yellow 154 |
| | | CI Yellow 175 |
| | | CI Yellow 181 |
| | | CI Yellow 194 |
| Azo Condensation Yellows | Azo Cond. | CI Yellow 95 |
| | | CI Yellow 93 |
| | | CI Yellow 94 |
| | | CI Yellow 128 |
| | | CI Yellow 166 |
| Isoindolinone Yellows | | CI Yellow 110 |
| | | CI Yellow 139 |
| | | CI Yellow 109 |
| | | CI Yellow 173 |
| Quinophthalone Yellow | | CI Yellow 138 |

Orange Pigments

| | | |
|---|---|---|
| Pyrazolone Orange | Pyrazolone | CI Orange 13 |
| | | CI Orange 34 |
| Perinone Orange | Perinone | CI Orange 43 |
| Benzimidazolone Orange | Mono Azo | CI Orange 36 |
| Pigments | | CI Orange 60 |
| | | CI Orange 62 |
| Diarylide Orange | Diarylide | CI Orange 16 |

Red Pigments

| | | |
|---|---|---|
| Red Iron Oxide | Synthetic Iron Oxide | CI Red 101 |
| Burnt Sienna | Natural Iron Oxide | CI Red 102 |
| BON Arylamide Red | BON Arylamide | CI Red 112 |
| Pigments | | CI Red 170 |
| Benzimidazolone Reds | Mono Azo | CI Red 185 |
| | | CI Red 171 |
| | | CI Red 175 |
| | | CI Red 176 |
| | | CI Red 208 |
| Diazo Cond. Reds | Cond, Diazo | CI Red 166 |
| | | CI Red 144 |
| | | CI Red 214 |
| | | CI Red 220 |
| | | CI Red 221 |
| | | CI Red 242 |
| Quinacridone Reds | Quinacridone | CI Red 202 |
| | | CI Red 122 |
| | | CI Red 192 |
| | | CI Red 207 |
| | | CI Red 209 |
| | | CI Violet 19 |
| Perylene Reds | Perylene | CI Red 224 |
| | | CI Red 123 |
| | | CI Red 149 |
| | | CI Red 178 |
| | | CI Red 179 |
| | | CI Red 190 |
| | | CI Violet 29 |
| Anthraquinone Reds | | CI Red 177 |

Green Pigments

| | | |
|---|---|---|
| Phthalocyanine Green | Phthalocyanine | CI Green 7 |

Brown Pigments

| | | |
|---|---|---|
| Burnt Umber/Sienna | Nat. Iron/Mang. Oxide | CI Brown 7 |
| Burnt Umber/Sienna | Synt. Iron/Mang. Oxide | CI Brown 6 |

Pearlescent Pigments

| | | |
|---|---|---|
| Pearlescent | Titanium treated Micas | CI White 6 |
| | | CI White 20 |

Pigment dispersing agents may also be used, which are readily commercially available. A suitable dispersing agent is Disperbyk, manufactured by BYK Chemie of Wesel, Germany. Preferably, the pigment and extended fillers comprise between about 30% pigment volume concentration (PVC) to about 50% PVC of the total composition of the sealer composite. In a preferred composition, the sealer composite includes 5% PVC TiO₂, and 25%-45% PVC extended fillers.

Alternative pigment dispersing agents include soft thermoplastic alkali soluble acrylic resins. Carboxylated acrylic resins are first solublised in alcoholic alkaline water. Aqueous ammonia or amines, alcohols, or glycol ethers may be used as cosolvents to aid in neutralization and adjust viscosity. The resulting solution is then mixed with the amino resin to form a stable water dilutable resin blend suitable as a grind vehicle for dispersing pigment. Examples of suitable acrylic resin types for this application include NeoCryl alkali soluble acrylic resins, such as NeoCryl Bt-20, NeoCryl BT-24 & NeoCryl BT-27 available from NeoResins Waalwijk of The Netherlands. Resins of this type may include the following suitable properties: percent solids: 40-45%; molecular weight range: 25,000 to 35,000 mol weight units; acid value range (mg/KOH/gram resin) 60-90; glass transition temperature range: (Tg oC) 15-30.

Low levels of co-solvents such as Iso-Propanol and Di-Propylene Glycol Methyl Ether may also be added to the pigment dispersing agents to reduce the viscosity and improve the flow of the pigment dispersion. Further additives to the thermosetting resin base may also be used to aid wetting of the pigment in the sealer composite during its application to cellulosic mat 16 after the sealer composite has been foamed to form foamed sealer 18. Suitable additives may include Surfynol 104DPM50, manufactured by Air Products of Allentown, Pennsylvania, or TEGO Foamex 805 de-foamer, manufactured by TH Goldsmidth of Essen, Germany.

To aid in the formation of foamed sealer 18, the sealer composite preferably includes a surfactant to assist in attaining the desired foaming level. Preferably, the surfactant comprises between about 0.1% to about 12% by weight of the total sealer composite. A range of suitable surfactants are commercially available from the four established chemical groups classified by the electrical charge on the surface active part of the dissociated molecule in water, namely anionic, cationic, nonionic, and amphoteric. Preferably, a surfactant selected from the anionic, cationic and nonionic groups is used. Suitable anionic surfactants include: sulphonic acids (—S₃—), such as alkane sulphonates, alkyl benzene sulphonates, alkyl napthalene sulphonates, amide sulphonates, ester sulphonates, and ether sulphonates; phosphoric acid esters (—PO4⁼), such as fatty alcohol, phosphoric acid esters, ether alcohol, and phosphoric acid esters; carboxylic acids (—COO⁻), such as fatty acid soaps, and sarcosinates; sulphuric acid esters (—OSO₂O⁻), such as fatty alcohols, ether alcohols, oils & esters, and amides. Suitable cationic surfactants include: simple amine salts; quaternary ammonium salts; and amido amines and imidazolines. Suitable nonionic surfactants include: ethers, such as amides, alcohols, alkyl phenols, amides, glycols, and thiols; esters, such as fatty acid-mono and fatty acid-di; amides; and amine oxides. In addition, conventional amphoteric surfactants may be added, such as alkyl amino fatty acids; alkyl betaine; sulphobetaine; and subsituted imidazoline.

The surfactant also aids the clean release of the collapsed and cured sealer coat from the face of platen 12 (and/or 14). A suitable commercially available surfactant based release agent is PAT-2529R from E and P Wurtz GmbH & Co, which preferably comprises between about 1% by weight and about 5% by weight of the sealer composite.

Exemplary sealer composites formed from a two-part mill base formulation and resin formulation are provided in the following examples:

### EXAMPLE 1

Part A: Mill Base Formulation—Batch Weight 9.800 kgs

| Components: | % Wt/Wt | % NVC | % Wt. Solids | S.G. | Liters | Kgs. | Dry Volume (L) |
|---|---|---|---|---|---|---|---|
| Water | 38.67 | 0.00 | 0.00 | 1.00 | 3.79 | 3.790 | 0.00 |
| 2% Tylose | 8.33 | 2.00 | 0.17 | 1.03 | 0.79 | 0.816 | 0.02 |
| H10,000 G4 | | | | | | | |
| Sol. | | | | | | | |
| Disperbyk-192 | 2.50 | 98.00 | 2.45 | 1.05 | 0.23 | 0.245 | 0.23 |
| Surfynol 104- | 0.42 | 50.00 | 0.21 | 0.93 | 0.04 | 0.041 | 0.02 |
| DPM50 | | | | | | | |
| Tego Foamex | 0.08 | 20.00 | 0.02 | 1.00 | 0.01 | 0.008 | 0.00 |
| 805 | | | | | | | |
| Tioxide TR92 | 10.00 | 100.00 | 10.00 | 4.05 | 0.24 | 0.980 | 0.24 |
| PoleStar 200P | 5.00 | 100.00 | 5.00 | 2.60 | 0.19 | 0.490 | 0.19 |
| Microtalc AT 1 | 35.00 | 100.00 | 35.00 | 2.85 | 1.20 | 3.430 | 1.20 |
| TOTAL: | 100.00 | | 52.84 | | 6.50 | 9.800 | 1.90 |

*Tylose ™ manufactured by Clariant GmbH of Germany is a water soluble cellulose ether; H10,000 designates this material as Hydroxyethyul Cellulose (HEC) of viscosity grade 10,000 cps made up as a 2% solution of water, delivered as a course granular powder of granular size <180 microns.

Formulation Constants:

| | |
|---|---|
| % PVC: | 86 |
| % PVC (TiO2): | 13 |
| % Weight Solids Content: | 53 |
| % Volume Solids Content: | 29 |
| VOC (g/liter): | 3 |

Quality Control Data:

All tests carried out at 26.7° C.

| | | |
|---|---|---|
| Brookfield Viscosity (cps): | RV-DVII-No. 4-20 RPM: | 2032 |
| | RV-DVII-No. 4-50 RPM: | 1312 |
| | RV-DVII-No. 4-100 RPM: | 1312 |
| pH: | | 7.52 |
| Fineness of Grind (um): | | >7 |
| Specific Gravity: | | 1.37 |
| Oven Solids (% wt./wt.): | | 52.67 |

Part B: Resin Letdown Solution—Batch Weight 9.800 kgs

| Components: | % Wt/Wt | % NVC | % Wt. Solids | S.G. | Liters | Kgs. | Dry Volume (L) |
|---|---|---|---|---|---|---|---|
| L311 UF Resin | 60.00 | 57.70 | 34.62 | 1.23 | 4.78 | 5.880 | 2.76 |
| Tylose H10,000 | 40.00 | 2.00 | 0.80 | 1.03 | 3.81 | 3.920 | 0.08 |
| G4 2% | | | | | | | |
| TOTAL: | 100.00 | | 35.42 | | 8.59 | 9.800 | 2.83 |

*L311 is a water soluble urea formaldehyde resin supplied by Dynea, a Finland based company.

Quality Control Data:

All tests carried out at 25° C.

| | | |
|---|---|---|
| Brookfield Viscosity (cps): | RV-DVII-No. 4-100 RPM: | 908 |

Mixing Procedure:

Add all components of Mill Base Formulation progressively in the order listed above under medium speed (2000 RPM);

Disperse at high speed (6000 RPM) for about 20 minutes, then adjust to slow speed (1000 RPM) and add Resin Formulation; and

Mix for additional 10 minutes.

Part A & Part B+Surfactant—Sealer Composite Formulation

Batch Weight=20.00 Kgs

| Components: | % Wt/Wt | % NVC | % Wt. Solids | S.G. | Liters | Kgs. | Dry Volume (L) |
|---|---|---|---|---|---|---|---|
| Water | 18.948 | 0.00 | 0.00 | 1.00 | 3.79 | 3.790 | 0.00 |
| 2% Tylose | 4.082 | 2.00 | 0.080 | 1.03 | 0.79 | 0.816 | 0.02 |
| H10,000 G4 | | | | | | | |
| Sol. | | | | | | | |
| Disperbyk-192 | 1.225 | 98.00 | 1.20 | 1.05 | 0.23 | 0.245 | 0.23 |
| Surfynol 104- | 0.204 | 50.00 | 0.10 | 0.93 | 0.04 | 0.041 | 0.02 |
| DPM50 | | | | | | | |
| Tego Foamex | 0.041 | 20.00 | 0.01 | 1.00 | 0.01 | 0.008 | 0.00 |
| 805 | | | | | | | |
| Tioxide TR92 | 4.900 | 100.00 | 4.90 | 4.05 | 0.24 | 0.980 | 0.24 |
| PoleStar 200P | 2.450 | 100.00 | 2.45 | 2.60 | 0.19 | 0.490 | 0.19 |
| Microtalc AT 1 | 17.150 | 100.00 | 17.15 | 2.90 | 1.18 | 3.430 | 1.18 |
| L311 UF Resin | 29.4 | 57.70 | 16.96 | 1.23 | 4.78 | 5.880 | 2.76 |
| Tylose | 19.60 | 2.00 | 0.39 | 1.03 | 3.81 | 3.920 | 0.08 |
| H10,000G4 2% | | | | | | | |
| solution | | | | | | | |
| Ifrapon LOS NF | 2 | 28.00 | 0.56 | 1.04 | 0.38 | .400 | 0.11 |
| TOTAL: | 100.00 | | 43.81 | | 15.45 | 20.00 | 4.82 |

Formulation Constants:

| | |
|---|---|
| % PVC | 33 |
| % PVC (TiO2) | 5 |
| % weight solids | 44 |
| % Volume solids | 31 |
| VOC (g/liter) | 1 |

Quality Control Data:

All tests carried out at 26.7° C.

| | | |
|---|---|---|
| Brookfield Viscosity (cps): | RV-DVII-No. 4-20 RPM: | 1240 |
| | RV-DVII-No. 4-50 RPM: | 952 |
| | RV-DVII-No. 4-100 RPM: | 750 |
| pH: | | 8.52 |
| Fineness of Grind (um): | | >6.5 |
| Specific Gravity: | | 1.246 |
| Oven Solids (% wt./wt.): | | 41.57 |
| Final Foam Density (g/cc): | | 0.271 |

### EXAMPLE 2

Clear Sealer Composite: Batch Weight 18.9 kgs

| Components: | % wt./wt | S.G. | Kgs. | Liters |
|---|---|---|---|---|
| L311 UF Resin | 44.444 | 1.000 | 8.400 | 8.400 |
| Tylose H10,000P2 2% | 44.444 | 1.000 | 8.400 | 8.400 |
| Tap Water | 6.112 | 1.000 | 1.155 | 1.155 |
| Ifrapon LOS | 5.000 | 1.040 | 0.945 | 0.909 |
| TOTAL: | 100.000 | | 18.900 | 18.864 |

*Ifrapon LOS is a fatty alcohol ether sulphate, 28% sodium laurylether sulfate solution in water.

Quality Control Data:

All tests carried out at 25° C.

| | | |
|---|---|---|
| Brookfield Viscosity cps: | RVDVII-No. 4-100 RPM: | 1424 |
| S.C.: | | 1.05 |

Blending Procedure:

Weight 8.4 kgs of L311 into 20 liter bucket;

Add 8.4 kgs of tylose solution while hand stirring with stick;

Add 1.155 kgs of cold tap water; and

Add 0.945 kgs of soap and stir mix well for about 5 minutes.

### EXAMPLE 3

Water Based Acrylic Pigment Dispersant Solution: Batch Weight 3000 kgs

| Components: | % wt./wt | % NVC | % wt. solids | S.G. | Liters | Kgs |
|---|---|---|---|---|---|---|
| 1) Neocryl BT-27 | 55.00 | 45.00 | 24.75 | 1.06 | 1556.60 | 1650.000 |
| 2) Water | 39.85 | 0.00 | 0.00 | 1.00 | 1195.50 | 1195.500 |
| 3) Dowanol DPM | 3.00 | 0.00 | 0.00 | 0.95 | 94.74 | 90.000 |
| 4) Aqueous Ammonia | 1.65 | 0.00 | 0.00 | 0.89 | 55.62 | 49.500 |
| Sol (25%) | | | | | | |
| 5) Surfynol 104DPM-50 | 0.50 | 50.00 | 0.25 | 0.93 | 16.13 | 15.000 |
| TOTAL | 100.00 | | 25.00 | | 2918.59 | 3000.000 |

Quality Control Data:

Brookfeild viscosity (cps): RV-DVII—Spindle No.5-100 rpm: 2500-2900

pH: 8.5-8.9

Specific Gravity: 1.01

Oven Solids: (% wt/wt): 24.5-24.8

Blending Procedure:

Mix components 1, 2, 3, 4 until resin emulsion is in full solution.

Maintain pH level between 8.5 and 8.9; add further small amounts of aqueous Ammonia if required to adjust pH to correct level.

Add component 5 under low speed mixing to complete the blend.

Filter solution through 100 micron rated nylon mesh filter bag.

### EXAMPLE 4

Part A: Pigment Dispersion Formulation—Batch Weight 1000 kgs

| | | % | % | | | | Dry |
|---|---|---|---|---|---|---|---|
| Components: | % Wt/Wt | NVC | Wt. Solids | S.G. | Liters | Kgs. | Volume (L) |
| Neocryl BT-27-01 | 30.60 | 25.00 | 7.65 | 1.06 | 288.68 | 306.00 | 72.17 |
| Resin Solution | | | | | | | |
| Dynomel LD | 14.20 | 59.50 | 8.45 | 1.10 | 129.09 | 142.00 | 76.81 |
| RD03-304 Liquid | | | | | | | |
| Resin | | | | | | | |
| Disperbyk-192 | 2.00 | 98.00 | 1.96 | 1.05 | 19.05 | 20.00 | 18.67 |
| Iso-propanol | 2.00 | 0.00 | 0.00 | 0.80 | 25.00 | 20.00 | 0.00 |
| Dowanol DPM | 3.00 | 0.00 | 0.00 | 0.90 | 33.33 | 30.00 | 0.00 |
| Surfynol 104- | 0.50 | 50.00 | 0.25 | 0.93 | 5.38 | 5.00 | 2.69 |
| DPM50 | | | | | | | |
| Tego Foamex 805 | 0.20 | 20.00 | 0.04 | 1.00 | 2.00 | 2.00 | 0.40 |
| Tioxide R-XL | 35.00 | 100.00 | 35.00 | 3.55 | 98.59 | 350.00 | 98.59 |
| Opacalite | 10.00 | 100.00 | 10.00 | 2.05 | 48.78 | 100.00 | 48.78 |
| Distilled Water | 2.50 | 100.00 | 2.50 | 3.05 | 8.20 | 25.00 | 8.20 |
| TOTAL: | 100.00 | | 65.85 | | 658.10 | 1000.00 | 326.30 |

Formulation Constants:

| | |
|---|---|
| % PVC: | 45 |
| % PVC (TiO2): | 30 |
| % Weight Solids Content: | 66 |
| % Volume Solids Content: | 50 |
| VOC (g/liter): | 80 |

Quality Control Data:

All tests carried out at 25.0° C.

| | | |
|---|---|---|
| Brookfield Viscosity (cps): | RV-DVII-No. 3-100 RPM: | 758 |
| pH: | | 7.5 |
| Fineness of Grind (um): | | <10 microns |
| Specific Gravity: | | 1.36 |
| Oven Solids (% wt./wt.): | | 61.75 |

Mixing Procedure:

Add all components progressively in the order shown above under a medium speed of about 2000 RPM.

Disperse at a relatively high speed of about 4000 RPM for about 10 minutes, then adjust Disperant to slow speed of about 1000 RPM.

Allow mix to cool to room temperature, and place ss beaker in a vessel of cold tap water.

Sample mix and carry out QC tests; add water to adjust viscosity of formulation to 1500-2000 cps.

Calculation of peripheral speed (mSec⁻¹): 4000
πD×RPM/60=13.6 RPM

Part B: Resin Letdown Solution—Batch Weight 5000 kgs

| | % | % | % | | | | Dry |
|---|---|---|---|---|---|---|---|
| Components: | Wt/Wt | NVC | Wt. Solids | S.G. | Liters | Kgs. | Volume (L) |
| Pigment Dispersion: | 20.00 | 65.85 | 13.17 | 1.42 | 704.23 | 1000.00 | 463.73 |
| MB-010(LD RD03-304) | | | | | | | |
| Dynomel LD RD03-304 | 74.50 | 59.50 | 44.33 | 1.06 | 3514.15 | 3725.00 | 2090.92 |
| Liquid Resin | | | | | | | |
| Wurtz Release Agent | 5.00 | 20.00 | 1.00 | 1.02 | 245.10 | 250.00 | 49.02 |
| PAT-2529R | | | | | | | |
| Ifrapon LOS Soap | 0.50 | 100.00 | 0.50 | 1.02 | 24.51 | 25.00 | 24.51 |
| TOTAL: | 100.00 | | 59.00 | | 4487.98 | 5000.00 | 2628.18 |

Quality Control Data:

All tests carried out at 25° C.

| | | |
|---|---|---|
| Brookfield Viscosity (cps): | RV-DVII-No. 3-100 RPM: | 570 |
| pH: | | 7.87 |
| Fineness of Grind (um): | | <10 microns |
| Oven Solids: (% wt/wt): | | 58.5 |

Formulation Constants:

| | |
|---|---|
| % PVC: | 6 |
| % PVC (TiO2): | 4 |
| % Weight Solids Content: | 59 |
| % Volume Solids Content: | 59 |
| VOC (g/liter): | 11.7 |

After the sealer composite has been modified with any desired additives, it is then foamed to form foamed sealer 18. The sealer composite may be foamed using a continuous, mechanically agitating aerating mixer, such as an aerating mixer available from Mondomix B.V. of the Netherlands. Preferably, foamed sealer 18 has a foam density of between about 150 Kg/m³ to about 250 Kg/M³. The resulting foamed sealer 18 is then applied to at least one major surface 20 of cellulosic mat 16.

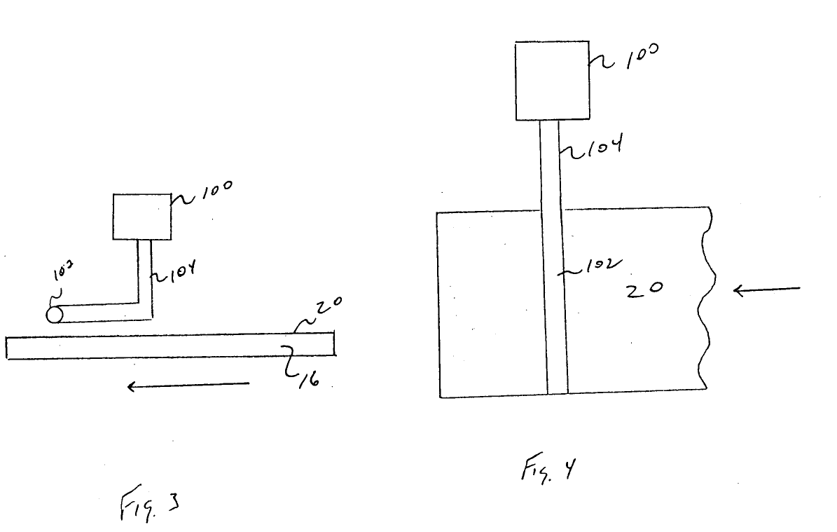

As best shown in FIG. 3, mixer 100 communicates with slotted manifold 102 through piping 104. Foamed sealer 18 may be applied onto surface 20 of cellulosic mat 16, preferably using a pressurized, slotted manifold (i.e. a sheeting manifold) 102, which provides for a relatively high-speed application of foamed sealer 18. The mat 16 advances under manifold 102 in the direction of the arrows, as best shown in FIGS. 3 and 4. The mixer 100 has a mixing head that supplies foamed sealer 18 to the slotted manifold 102. A feed pump and pressure regulator are operably associated with the mixer 100 and manifold 102, and provide sufficient pressure to advance foamed sealer 18 through the piping 104 to the manifold 102 for application. Preferably, a pressure of between about 3 bar to about 6 bar is provided at the mixing head.

Preferably, an even coating of foamed sealer 18 is applied across major surface 20, so that foamed sealer 18 has a substantially uniform thickness, preferably between about 1.0 mm to about 3.0 mm. The manifold 102 preferably includes a metered slot having a width of between about 1.0 mm to about 25.0 mm. The distance between the manifold slot and major surface 20 of cellulosic mat 16 is preferably between about 20 mm to about 150 mm. The angle of the manifold slot relative to cellulosic mat 16 is preferably between about 450 and about 90°. As foamed sealer 18 exits the manifold slot, it has a preferred foam density of between about 100 kilograms per meter cubed (kg/m³) to about 500 kg/m³, more preferably about 150 kg/m³ to 220 kg/m³.

The manifold 102 preferably extends the width of mat 16. A preferred coating width is about 1800 mm. The internal diameter of the manifold tube may vary depending on the throughput requirements. Preferably, throughput is between about 7.5 kg/min to about 15 kg/min. Application rate of foamed sealer 18 may be controlled by adjusting slot width, forming line speed, and/or feed pump rate on the mixer via a programmable logic controller. While we illustrate the foam sealer 18 being applied to individual mats 16, those skilled in the art recognize that the mat could be continuous in order to permit uninterrupted dispensing of foam sealer 18. In that event, the individual mats 16 would be formed by cutting or otherwise severing the foam-covered mat.

It should be understood that other devices for applying foamed sealer 18 may also be used, such as a foam extruder. However, the device should apply foamed sealer 18 so that major surface 20 of cellulosic mat 16 is not disturbed during the application process.

After applying foamed sealer 18 on cellulosic mat 16, the foam-covered mat is compressed in press 10 between upper and lower press platens 12, 14 through the application of heat and pressure, as known in the art. Preferably, the temperature of press platens 12, 14 ranges from between about 140° C. and about 225° C. during compression, more preferably between about 140° C. and about 165° C. during compression. Press 10 is preferably a hydraulic press system, applying between about 900 pounds per square inch (psi) to about 1500 psi of pressure, more preferably between about 1000 psi to about 1200 psi, during the press cycle.

Preferably, a relatively slow press cycle is used, for example a press cycle time of about 70 seconds, so that foamed sealer 18 collapses at a progressive, controlled rate. The press cycle rate preferably permits degassing of volatiles and hydrocarbons that are released from foamed sealer 18. However, it should be understood that press cycle time may vary depending on platen temperature, applied pressure, and the thickness and characteristics of mat 16 and foamed sealer 18. A preferred press temperature during de-foaming is between about 65° C. to about 70° C.

After compression, upper and lower press platens 12, 14 are released. A resulting consolidated cellulosic article 30 having a sealer coat 32 may then be removed from press 10, as best shown in FIG. 2. During compression, foamed sealer 18 collapses or “de-foams” due to the applied heat and pressure. Preferably, foamed sealer 18 is substantially de-foamed prior to consolidation of cellulosic mat 16 to provide for adequate heat transfer between platens 12, 14 and mat 16 during pressing.

During compression, the resin in foamed sealer 18 cross-links to form sealer coat 32. The percentage and rate of cross-linking of the resin may be controlled by adjusting the press time and temperature. The thickness of sealer coat 32 may vary depending on consumer preference, but is preferably between about 90 microns and about 130 microns. In addition, sealer coat 32 preferably has a substantially uniform caliper relative to underlying surface 34 of molded article 30, as best shown in FIG. 2. Sealer coat 32 has a specific gravity of between about 0.70 to about 1.50, preferably between about 1.06 to about 1.37, more preferably between about 1.10 to about 1.35. Sealer coat 32 may be clear, or pigmented if pigmentation was added to the sealer composite as described above. In addition, the flexibility and hardness of sealer coat 32 may vary depending on the specific modifiers added to the sealer composite.

The formaldehyde-based composition of sealer coat 32 enhances press release, because the cross-linked resin is not prone to sticking to press platen 12 when mold platens 12 and 14 are opened. This is beneficial, because an excellent surface quality is achieved upon release of the consolidated mat from the platens. Any tendency to stick to press mold platen 12 is minimized due to the cross-linking characteristics of the resin. Any sticking to platen 14 is not as important, because it is thus on the interior side of the door skin, which is not normally visible on a completed door. The cross-linking also increases surface hardness, which in turn increases paint hold-out. In addition, sealer coat 32 is relatively water impermeable, providing better stability in the presence of high humidity. However, sealer coat 32 is permeable to stain and/or paint, and therefore has excellent paintability.

Sealer coat 32 may be pigmented to achieve a desired coloration of molded article 30. Thus, sealer coat 32 eliminates problems associated with surface spotting and discoloration, which may be caused by migration of wood tannin, sugars and/or waxes present in the wood fibers and/or cellulosic mat 16. Furthermore, the need for an additional primer or sealer coating after the compression process is eliminated, thereby further reducing manufacturing costs. An out-of-press consolidated article 30 having uniform coloration is thus provided, ready for use as a door facing, wainscot, trim, and the like.

Sealed, molded article 30 is relatively inexpensive to manufacture given no additional priming or sealing steps are required after compression. The disclosed invention is substantially less expensive than other methods involving latex-based sealer formulations, given latex is relatively expensive. In addition, manufacturing efficiency is optimized in the present invention because foamed sealer 18 is de-foamed, compressed and cross-linked in press 10 in-press after its application. However, no additional processing steps are required, such as a foam collapsing period prior to compressing platens 12, 14. Generally, conventional methods involving foamed sealers require that the foam be collapsed before compression is permissible.

In a preferred embodiment, molded cellulosic article 30 is a door facing having sealer coat 32 on a surface 34 to be exteriorly disposed. The door facing is used to form a door. As well known in the art, a door comprises a peripheral frame and first and second door facings. The facings each have an exterior surface and an interior surface secured to opposing sides of the frame, respectively. The door may also include a door core disposed between the interior surfaces of the opposing facings.

At least one of the door facings includes sealer coat 32 on its exterior surface. As described above, sealer coat 32 comprises a latex-free, thermosetting resin such as urea formaldehyde, phenol formaldehyde, melamine formaldehyde, melamine urea formaldehyde, and mixtures thereof In addition, sealer coat 32 preferably has a substantially uniform thickness. When used to form a door facing, sealer coat 32 may include the above noted modifiers and additives.

Additional examples of sealer compositions suitable for use with the manufacture of a door skin are provided:

### EXAMPLE 5

| | |
|---|---|
| Sealer Composite: | Example 2 |
| Viscosity: | Brookfield RVDV11: Spindle No. 4: |
| | 100 RPM: = 1400 cps |
| Pump Feed Rate: | 10 liters/hour (Pot. Meter set at 222) |
| Air to Mixing Head: | 52.5 liters/hour |
| Mixing Head Speed: | 500 RPM (Pot. Meter set at 300) |
| Wax Cup Capacity: | 410 cc calibrated with water |
| Delivery Hose Length after | 7 meters |
| mixing head: | |
| Mixing Head Pressure: | 3.1 Bar |
| S.G. in to machine: | 1.05 |
| S.C. out of machine: | 0.217 |
| Temperature In: | 18° C. |
| Temperature Out: | 19° C. |

Excellent foaming achieved.

### EXAMPLE 6

| | |
|---|---|
| Sealer Composite: | Example 2 |
| Viscosity: | Brookfield RVDV11: Spindle No. 4: |
| | 100 RPM: = 1400 cps |
| Pump Feed Rate: | 8 liters/hour (Pot. Meter set at 222) |
| Air to Mixing Head: | 42.5 liters/hour |
| Mixing Head Speed: | 500 RPM (Pot. Meter set at 300) |
| Wax Cup Capacity: | 410 cc calibrated with water |
| Delivery Hose Length after | 7 meters |
| mixing head: | |
| Mixing Head Pressure: | 3.1 Bar |
| S.G. in to machine: | 1.05 |
| S.G. out of machine: | 0.160 |
| Temperature In: | 18° C. |
| Temperature Out: | 19° C. |

Excellent foaming was again achieved. The foamed mix of Example 6 was applied through a sheeting manifold, which was temporarily supported with 30 mm wooden stiles above a flat panel of a doorskin. This provided a clearance of about 27 mm between the bottom lip of manifold and the top surface of the panel. The foam was easily applied to the top surface, without ruffling the top surface of the mat.

It will be apparent to one of ordinary skill in the art that various modifications and variations can be made in configuration or formulation of the present invention without departing from the scope or spirit of the invention. Thus, it is intended that the present invention cover all such modifications and variations, provided they come within the scope of the following claims and their equivalents.

1. A method of making a consolidated cellulosic article, comprising the steps of:
providing a cellulosic mat;
applying to the cellulosic mat a latex-free, foamed sealer comprising a thermosetting resin;
positioning the foam covered mat between upper and lower platens of a press; and
compressing the foam covered cellulosic mat between the upper and lower platens using heat and pressure, and de-foaming the foamed sealer during said compressing to form a consolidated article having a sealer coat.

2. The method of claim 1, including the step of applying to the cellulosic mat a latex-free, foamed sealer selected from the group consisting of urea formaldehyde, phenol formaldehyde, melamine formaldehyde, melamine urea formaldehyde, and mixtures thereof.

3. The method of claim 2, comprising the further steps of:
providing a sealer composite prior to said applying step; and
foaming the sealer composite to form the latex-free, foamed sealer.

4. The method of claim 3, including the step of mixing the sealer composite into a foam.

5. The method of claim 3, including the step foaming the sealer composite to form the latex-free, foamed sealer having a foam density of between about 100 kg/m³ and about 500 kg/m³.

6. The method of claim 3, including the step of modifying the sealer composite with a surfactant.

7. The method of claim 6, including the step of providing a surfactant selected from the group consisting of sulphonic acids (—SO₃—), phosphoric acid esters (—PO4⁼), carboxylic acids (—COO⁻), sulphuric acid esters (—OSO₂O⁻), simple amine salts, quaternary ammonium salts, amido amines, imidazolines, ethers, esters, such as fatty acid-mono and fatty acid-di, amides, amine oxides, alkyl amino fatty acids, alkyl betaine, sulphobetaine, and subsituted imidazoline.

8. The method of claim 7, wherein the sulphonic acid (—SO₃—) is selected from the group consisting of alkane sulphonates, alkyl benzene sulphonates, alkyl napthalene sulphonates, amide sulphonates, ester sulphonates, and ether sulphonates.

9. The method of claim 7, wherein the phosphoric acid ester (—PO4⁼) is selected from the group consisting of fatty alcohols, phosphoric acid esters, ether alcohol, and phosphoric acid esters.

10. The method of claim 7, wherein the carboxylic acid (—COO⁻) is selected from the group consisting of fatty acid soaps and sarcosinates.

11. The method of claim 7, wherein the sulphuric acid ester (—OSO₂O⁻) is selected from the group consisting of fatty alcohols, ether alcohols, oils, esters, and amides.

12. The method of claim 7, wherein the ether is selected from the group consisting of amides, alcohols, alkyl phenols, amides, glycols, and thiols.

13. The method of claim 7, wherein the ester is selected from the group consisting of fatty acid-mono and fatty acid-di.

14. The method of claim 3, including the step of modifying the sealer composite with at least one of a pigment, a plasticizer, and a thickener prior to said foaming step.

15. The method of claim 14, including the step of providing a pigment comprising titanium dioxide and extender fillers.

16. The method of claim 15, wherein the extender fillers are selected from the group consisting of clay, talc, calcium carbonate, and zinc oxide.

17. The method of claim 14, including the step of adding to the sealer composite a plasticizer selected from the group consisting of acetoguanamine, caprolactam, para-toluene sulphonamide, phthalate plasticizer, aliphatic plasticiser, an adipate, a flame retardant plasticiser, and a non-migratory polymeric plasticiser.

18. The method of claim 17, wherein the phthalate plasticizer is selected from the group consisting of DEHP (di-2-ethylhexyl phthalate), DOP (di-octyl phthalate), DIDP (di-isodecyl phthalate), DINM (di-isononyl phthalate), BBP (butyl benzyl phtalate), DIHP (di-isoheptyl phthalate), and DPHP (di-propyl heptyl phthalate).

19. The method of claim 17, wherein the aliphatic plasticiser is selected from the group consisting of TXIB (Eastman chemicals) 2,2,4-Trimethyl-1,3-Pentanediol, and Diisobutrate

20. The method of claim 17, wherein the adipate is DEHA (diethylhexyl adipate).

21. The method of claim 17, wherein the flame retardant plasticizer is a phosphate ester plasticiser.

22. The method of claim 14, including the step of providing a thickener selected from the group consisting of methyl cellulose, methylhydroxyethyl cellulose, methylhydroxypropyl cellulose, hydroxyethyl cellulose, a polyurethane-based thickener, and an ammonium polyacrylate-based thickener.

23. The method of claim 1, including the step of using a pressurized, slotted manifold for said applying step.

24. The method of claim 1, including the step of providing a latex-free, foamed sealer having a viscosity of between about 200 cps to about 5000 cps.

25. The method of claim 1, including the step of heating the platens to a temperature of between about 140° C. and about 225° C. during said compressing step.

26. The method of claim 1, including the step of applying from about 900 psi to about 1500 psi of pressure during said compressing step.

27. The method of claim 1, wherein said compressing step comprises a press cycle time of about 70 seconds.

28. A door, comprising:
a peripheral frame having opposing sides;
first and second door facings, each of said facings having an exterior surface and an interior surface secured to one of the sides of said frame;
a sealer coat on at least one of said exterior surfaces, said sealer having a substantially uniform thickness, and said sealer coat comprising a latex-free, thermosetting resin selected from the group consisting of urea formaldehyde, phenol formaldehyde, melamine formaldehyde, melamine urea formaldehyde, and mixtures thereof.

29. The door of claim 28, wherein said sealer coat further comprises a pigment.

30. The door of claim 29, wherein said pigment comprises titanium dioxide and extender filler.

31. The door of claim 30, wherein said filler are selected from the group consisting of clay, talc, calcium carbonate, and zinc oxide.

32. The door of claim 28, wherein said sealer coat further comprises a plasticizer selected from the group consisting of acetoguanamine, caprolactam, para-toluene sulphonamide, a phthalate plasticizer, an aliphatic plasticiser, an adipate, a flame retardant plasticiser, and a non-migratory polymeric plasticiser.

33. The method of claim 32, wherein the phthalate plasticizer is selected from the group consisting of DEHP (di-2-ethylhexyl phthalate), DOP (di-octyl phthalate), DIDP (di-isodecyl phthalate), DIP (di-isononyl phthalate), BBP (butyl benzyl phtalate), DIHP (di-isoheptyl phthalate), and DPHP (di-propyl heptyl phthalate).

34. The method of claim 32, wherein the aliphatic plasticiser is selected from the group consisting of TXIB (Eastman chemicals) 2,2,4-Trimethyl-1,3-Pentanediol, and Diisobutrate

35. The method of claim 32, wherein the adipate is DEHA (diethylhexyl adipate).

36. The method of claim 32, wherein the flame retardant plasticizer is a phosphate ester plasticiser.

37. The door of claim 28, wherein said sealer coat further comprises a thickener selected from the group consisting of methyl cellulose, methylhydroxyethyl cellulose, methylhydroxypropyl cellulose, hydroxyethyl cellulose, a polyurethane-based thickener, and an ammonium polyacrylate-based thickener.

38. The door of claim 28, wherein said sealer coat has a specific gravity of between about 0.70 and 1.50.

39. A door facing, comprising:
an exterior surface, and an interior surface for being secured to a door frame frame;
a sealer coat covering said exterior surface, said sealer coat having a substantially uniform thickness and comprising a latex-free, thermosetting resin selected from the group consisting of urea formaldehyde, phenol formaldehyde, melamine formaldehyde, melamine urea formaldehyde, and mixtures thereof.

40. A method of forming a sealed consolidated composite article, comprising the steps of:
advancing an unconsolidated cellulosic mat under a dispensing head;
dispensing a uniform layer of foamed sealer from the head onto the mat;
positioning the foam-covered mat between the platens of a press;
closing the platens and applying pressure and heat and thereby collapsing and cross-linking the foam and consolidating the mat; and
opening the platens and removing the sealed, consolidated composite article.
